(19) United States
(12) Patent Application Publication
(10) Pub. No.: US 2017/0193958 A1
(43) Pub. Date: Jul. 6, 2017

(54) DRIVE CIRCUIT AND METHOD FOR IMPROVING DISPLAY EFFECT OF LCD, AND LIQUID CRYSTAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zhiyong Wang, Beijing (CN); Shuai Xu, Beijing (CN); Hongjun Yu, Beijing (CN); Hong Zhu, Beijing (CN)

(21) Appl. No.: 15/106,206

(22) PCT Filed: Oct. 19, 2015
(86) PCT No.: PCT/CN2015/092176

§ 371 Date: Jun. 17, 2016

(30) Foreign Application Priority Data
Jun. 25, 2015 (CN) 201510359815.3

(51) Int. Cl. G09G 3/36

(52) U.S. Cl. CPC G09G 3/3696; G09G 2310/0291; G09G 2320/0233

(57) ABSTRACT

A drive circuit and a method for improving display effect of LCD and a liquid crystal display device are disclosed. The drive circuit for improving display effect of LCD comprises a display data storage unit, a voltage difference storage unit and a central processor. The liquid crystal display device comprises the drive circuit for improving display effect of LCD according to the above technical solution. The method for improving display effect of LCD may utilize the drive circuit for improving display effect of LCD. A drive method of the liquid crystal display device may comprise the method for improving display effect of LCD.

### TECHNICAL FIELD

The present disclosure generally relates to field of liquid crystal display technologies, and specifically, to a drive circuit and a method for improving display effect of LCD and a liquid crystal display device.

### BACKGROUND

A glass substrate used in an amorphous silicon liquid crystal display has a low cost, and such display is simply in manufacturing process. To improve its display effect, researchers have performed data process for display data when a TFT-LCD is being driven, and pixel arrangement in the TFT-LCD has also been redesigned to cooperate with the data process. This redesign is different from commonly used Strip type arrangement, and in the redesigned arrangement, an order of three primary colors, i.e., red, green and blue, has been disrupted to increase transmissivity when the TFT-LCD is displaying, and thereby display effect of the TFT-LCD has been improved.

However, when driving the TFT-LCD screen to work, since time delays exist in signals of display data, sub-pixels having the same color may have different brightness due to difference in arrangement of their peripheral sub-pixels, which leads to a bad overall display effect of a displayed picture.

### SUMMARY

An object of the present disclosure is to provide a drive circuit and a method for improving display effect of LCD and a liquid crystal display device, so as to overcome the problem of bad display effect of a displayed picture due to time delay of display signals.

To realize the object, the following technical solutions are provided in the present disclosure.

In a first aspect, there is provided a drive circuit for improving display effect of a LCD, the drive circuit may comprises a display data storage unit, a voltage difference storage unit and a central processor, wherein

the display data storage unit is configured to store original display data and sampling display data;

the central processor is connected with the display data storage unit and the voltage difference storage unit respectively; and

the central processor is configured to: input the sampling display data in the display data storage unit to respective pixel units of the LCD, obtain measured voltage data input on the respective pixels corresponding to the sampling display data, obtain voltage difference data based on the measured voltage data, revise the original display data in the display data storage unit by the central processor based on the voltage difference data to obtain revised display data, and input the revised display data to the respective pixel units of the LCD.

In a second aspect, there is provided a liquid crystal display device, which may comprise the drive circuit for improving display effect of the LCD according to the first aspect.

In a third aspect, there is provided a method for improving display effect of a LCD, and the method may comprise steps of:

S1: inputting sampling display data to pixel units of the LCD;

S2: obtaining measured voltage data from the pixel units and obtaining voltage difference data based on the measured voltage data;

S3: revising original display data based on the voltage difference data so as to obtain revised display data; and

S4: using the revised display data to drive the respective pixel units of the LCD.

As compared with prior arts, the technical solutions of the present disclosure have the following beneficial effect:

in the drive circuit for improving display effect of LCD provided in the disclosure, the central processor may control the display data storage unit to output sampling display data to the pixel units; the voltage difference storage unit may sample voltages on the different pixel units corresponding to the sampling display data, then voltage difference data may be obtained based on the sampled voltages, and the original display data may be revised based on the voltage difference data, such that a defect of a difference in display brightness existing among sub-pixels of the same color in the same pixel unit may be eliminated, and thereby display effect of original display data in different pixel units may be improved, that is, an overall display effect of a picture may be improved.

### BRIEF DESCRIPTION OF THE DRAWINGS

The appended drawings described herein are to provide a further understanding of this disclosure and constitute a part of the disclosure. Exemplary embodiments of this disclosure and their description are to explicate the disclosure and shall not be regarded as a limitation to the disclosure.

FIG. 1 is a schematic structural drawing showing a drive circuit for improving display effect of a LCD according to an embodiment of the disclosure;

FIG. 2 is a schematic drawing showing an arrangement of pixels according to an embodiment of the disclosure;

FIG. 3 is a flow chart of a drive method for improving display effect of a LCD according to an embodiment of the disclosure;

FIG. 4 is another flow chart of a drive method for improving display effect of a LCD according to an embodiment of the disclosure;

FIG. 5 is a level diagram corresponding to Table 1 provided in an embodiment of the disclosure.

### DETAILED DESCRIPTION OF PREFERRED EMBODIMENTS

A drive circuit for improving display effect of a LCD, a liquid crystal display device and a drive method thereof provided in embodiments of the disclosure will be described in detail in conjunction with the appended drawings.

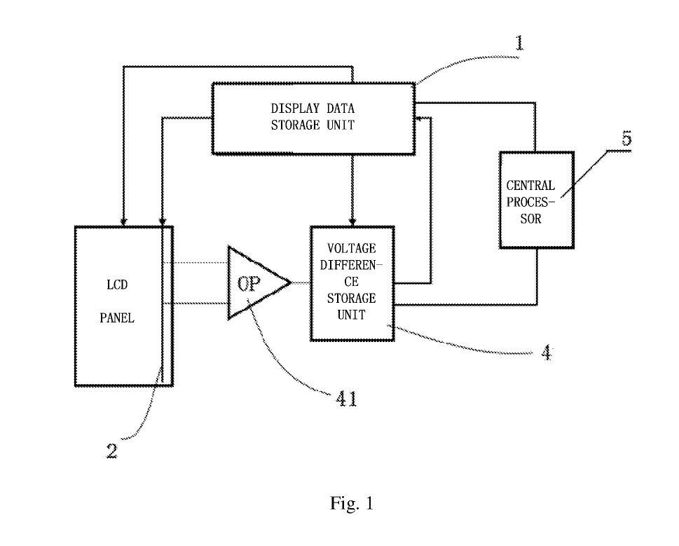

Please refer to FIG. 1, a drive circuit for improving display effect of a LCD according to an embodiment of the disclosure includes: a display data storage unit 1, a voltage difference storage unit 4 and a central processor 5; wherein the display data storage unit 1 is configured to store original display data and sampling display data; the central processor 5 is connected with the display data storage unit 1 and the voltage difference storage unit 4 respectively. The central processor 5 is configured to: input the sampling display data in the display data storage unit 1 to respective pixel units of the LCD, obtain measured voltage data on the pixel units corresponding to the sampling display data, obtain voltage difference data based on the measured voltage data; the central processor 5 revises the original display data in the display data storage unit 1 based on the voltage difference data to obtain revised display data, and input the revised display data to the pixel units of the LCD.

The original display data and/or the sampling display data as described above may be a set of voltage data, and when voltage values in the set of voltage data are applied to corresponding pixel units of the LCD respectively, the pixel units may display. A sampling unit measures voltage data of each of the pixel units, so as to obtain the measured voltage data and to obtain the voltage difference data based on values of the measured voltage data. Specifically, the sampling unit may measure voltages of sub-pixel units (for example, sub-pixel A and sub-pixel B) having the same color (or primary color) in a certain pixel unit. If the voltages are identical, then the two sub-pixels of the same color have the same brightness; and if the voltages are different, then the two sub-pixels of the same color have different brightness. Different brightness of sub-pixels of the same color in the same pixel unit will lead to a bad display effect of the display, thus the voltages of the two sub-pixels need to be revised or corrected. In an example, a difference between the voltages of sub-pixel A and sub-pixel B may be used as the voltage difference data. In another example, a difference between the voltage of sub-pixel A and a reference voltage (e.g., a voltage in the sampling display data or a voltage in the original display data) and a difference between the voltage of sub-pixel B and the reference voltage may be used as the voltage difference data. The two different ways will be described as follows.

In a first situation, that is, the difference between the voltages of sub-pixel A and sub-pixel B is used as the voltage difference data. If voltages in the sampling display data that correspond to the sub-pixel A and the sub-pixel B are identical while measured voltages thereof are different (presuming that measured voltage of sub-pixel A is higher than measured voltage of sub-pixel B), it means that voltage of the sub-pixels has been influenced by arrangement of sub-pixels in the pixel unit. In this condition, in order to make the sub-pixel A and the sub-pixel B have the same final display effect, a drive voltage provided to the sub-pixel A needs to be properly decreased and a drive voltage provided to the sub-pixel B need to be properly increased. For example, if it is desired that both actual drive voltages for sub-pixel A and for sub-pixel B in the original display data are 5 V, then firstly, in the sampling display data, drive voltages of 5 V are provided to the sub-pixel A and the sub-pixel B, and actual voltages (measured voltages) of the two sub-pixels when they are displaying are measured. Presuming that a measured voltage of sub-pixel A is 5.5 V and a measured voltage of sub-pixel B is 4.5 V, then a difference between the measured voltages of sub-pixels A and B is 1 V (5.5 V subtracts 4.5 V), and the original display data may be revised. For example, the voltage corresponding to the sub-pixel A in the original display data is revised to 4.5 V (i.e., the drive voltage for sub-pixel A is decreased by a half of the difference) and the voltage corresponding to the sub-pixel B in the original display data is revised to 5.5 V (i.e., the drive voltage for sub-pixel B is increased by a half of the difference). Then the revised voltages are used to drive the sub-pixel A and the sub-pixel B again, and at this time, measured voltages of sub-pixel A and sub-pixel B will more approach to 5 V respectively, such that display effects of sub-pixel A and sub-pixel B may become more consistent, and in turn, an overall display effect of LCD display panel or display device may be improved. However, the assumption above is just an ideal situation. Actually, it is possible that the measured voltage of sub-pixel A is 5 V and the measured voltage of sub-pixel B is 4V. In this situation, revised results of the voltages for sub-pixel A and sub-pixel B in the original display data are 4.5 V and 4.5 V respectively. In this situation, although sub-pixel A and sub-pixel B are not driven at desired voltages (5 V), at least display effects thereof become consistent.

In a second situation, that is, a difference between the voltage of sub-pixel A and a reference voltage (e.g., a voltage in the sampling display data or a voltage in the original display data) and a difference between the voltage of sub-pixel B and the reference voltage may be used as the voltage difference data. For example, if it is desired that both actual drive voltages for sub-pixel A and for sub-pixel B in the original display data are 5 V, then firstly, in the sampling display data, drive voltages of 5 V are provided to the sub-pixel A and the sub-pixel B, and actual voltages (measured voltages) of the two sub-pixels when they are displaying are measured. Presuming that a measured voltage of sub-pixel A is 5.4 V and a measured voltage of sub-pixel B is 4.4 V, then differences between the measured voltages of sub-pixels A and B and the reference voltage of 5 V are +0.4 V and -0.6 V respectively, and then the original display data may be revised. For example, the voltage corresponding to sub-pixel A in the original display data is revised to 4.6 V, i.e., 5−(+0.4)=4.6, and the voltage corresponding to sub-pixel B in the original display data is revised to 5.6 V, i.e., 5−(−0.6)=5.6. Then the revised voltages are used to drive the sub-pixel A and the sub-pixel B again, and at this time, measured voltages of sub-pixel A and sub-pixel B may be just 5 V respectively, such that display effects of sub-pixel A and sub-pixel B may become more consistent, and actual drive voltages for sub-pixel A and sub-pixel B are consistent with a desired value, thus an overall display effect of LCD display panel or display device may be improved.

In other exemplary embodiments, the sampling unit may measure voltages of a plurality of (or all) sub-pixels in a plurality of (or all) pixel units, then the measured voltages are compared with corresponding reference voltages in the sampling display data or in the original display data, and voltage difference data between corresponding measured voltages and corresponding reference voltages is calculated, and then corresponding voltages in the original display data may be revised based on the calculated voltage difference data.

In some other embodiments, if another sampling or more samplings are needed to perform a verification or a plurality of revisions are needed, the drive circuit may revise corresponding voltages in the sampling display data based on the obtained voltage difference data. Revised sampling display data may be used to drive the LCD for another time, to verify whether a desired effect has been realized by the last revision. If the desired effect has not been realized, previous revision process may be repeated to revise the original display data or the sampling display data again.

In another exemplary embodiment, the above original display data or sampling display data may be a driving picture (or image). To display the picture, the central processor 5 may convert the picture into a corresponding set of voltages and apply the set of voltages to corresponding sub-pixels. Therefore, basic principle of this embodiment is similar to the embodiment in which the sampling display data is a set of voltages as described above, thus a detailed description of this embodiment is omitted herein.

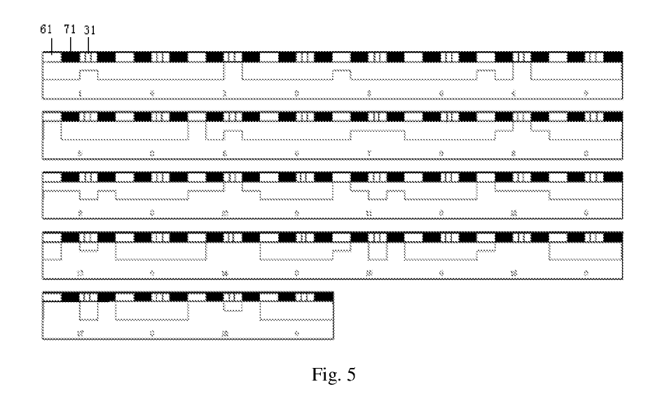

In still another exemplary embodiment, the above original display data and/or sampling display data may also be in a form of grayscale values. For example, Table 1 provides an exemplary table of gray values. When, for example, sub-pixels of a pixel unit are arranged in an order of RGBR (as shown in FIG. 5), a grayscale value of sub-pixels 31 having blue primary color, a grayscale value of sub-pixels 71 having green primary color and a grayscale value of sub-pixels 61 of red primary color correspond to three different voltage values. For example, a high voltage value of the three voltage values corresponds to a voltage of Lv255, a low voltage value of the three voltage values corresponds to a voltage of Lv0, and an intermediate voltage value of the three voltage values corresponds to a voltage of Lv127.

TABLE 1

| | | Lv0 | | | Lv127 | | | Lv255 | | |
|---|---|---|---|---|---|---|---|---|---|---|
| | | Grayscale value of blue | | | Grayscale value of blue | | | Grayscale value of blue | | |
| Grayscale value of | | primary color | | | primary color | | | primary color | | |
| green primary color | | Lv0 | Lv127 | Lv255 | Lv0 | Lv127 | Lv255 | Lv0 | Lv127 | Lv255 |
| Grayscale | Lv0 | 0 | 1 | 2 | 0 | 7 | 8 | 0 | 13 | 14 |
| value of | | | | | | | | | | |
| red | Lv127 | 3 | 0 | 4 | 9 | 0 | 10 | 15 | 0 | 16 |
| primary | | | | | | | | | | |
| color | Lv255 | 5 | 6 | 0 | 11 | 12 | 0 | 17 | 18 | 0 |

Table 1 is capable of storing 18 sets of data, which are represented by numerals 1 to 18 respectively. For example, each data location corresponds to grayscale values of sub-pixels of the three colors in one pixel unit, and the grayscale values in turn correspond to voltage values. Therefore, voltage values may be converted into and stored as grayscale values, and a revision to voltage values may be expressed as a revision to grayscale values. To be noted that, the Table 1 described above is just a non-limitative example, and grayscale values may be stored in other manners. Correspondingly, in this embodiment, the voltage difference data storage unit may comprises another grayscale value table for storing revised grayscale values, which may be retrieved and converted into corresponding voltages to drive the LCD display panel.

With the drive circuit for improving display effect of LCD display according to the embodiments of the disclosure, the central processor may control the display data storage unit to output the sampling display data to the respective pixel units; the voltage difference storage unit may sample voltages on the different pixel units corresponding to the sampling display data, then voltage difference data may be obtained based on the sampled voltages, and the original display data may be revised based on the voltage difference data, such that a defect of a difference in display brightness existing among sub-pixels of the same color in the same pixel unit may be eliminated, and thereby display effect of original display data in different pixel units may be improved, that is, an overall display effect of a picture may be improved.

To realize the function of the drive circuit for improving display effect of the LCD according to the above embodiment and the function of the voltage difference storage unit 4, a detailed description of a configuration of the voltage difference storage unit 4 is provided as follows.

Still referring to FIG. 1, the drive circuit further includes an operational amplifier, wherein the operational amplifier 41 is configured to obtain the measured voltage data and to process the measured voltage data to obtain the voltage difference data; the voltage difference storage unit 4 is configured to store the voltage difference data; the central processor 5 is further configured to retrieve the voltage difference data from the voltage difference storage unit 4. In an exemplary embodiment, the voltage difference storage unit 4 may be realized by various kinds of storage devices.

In the above embodiment, the drive circuit may also comprise a sampling unit including a sampling data line 2.

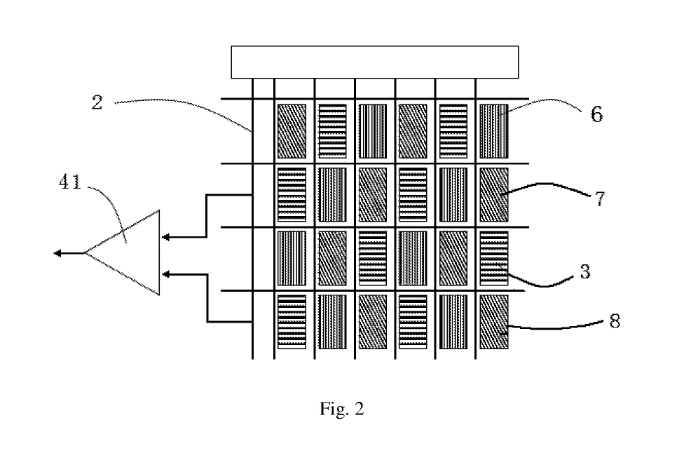

Referring to FIG. 2, the sampling data line 2 is configured to transmit the sampling display data and provide the measured voltage data to the operational amplifier 41. Because the sampling data line 2 can transmit voltage values corresponding to the sampling display data applied on different pixel units, the sampling data line 2 may realize the sampling on the voltage values of different pixel units or sub-pixels performed by the operational amplifier 41. Therefore, the sampling data line 2 acts as a bridge for transmission of the voltage values corresponding to the sampling display data applied on different pixel units.

Detailed description of principles and operations of the disclosure will be set forth in conjunction with the example shown in FIG. 2.

Still referring to FIG. 2, it can be seen that, along the same data line, a sub-pixel 7 in the second row and a sub-pixel 8 in the fourth row are green sub-pixel units, a sub-pixel 6 in the first row adjacent to the sub-pixel 7 of the second row is a red sub-pixel unit, and a sub-pixel 3 in the third row adjacent to the sub-pixel 8 of the fourth row is a blue sub-pixel unit. Since the sub-pixel 7 in the second row and the sub-pixel 8 in the fourth row are sub-pixel units having the same color, they have the same grayscale value. The sub-pixel 6 in the first row and the sub-pixel 3 in the third row are sub-pixel units having different colors and different voltages, therefore the sub-pixel 6 in the first row and the sub-pixel 3 in the third row have different influences on signal delays on the data line, which may lead to periodic brightness changes of the color block if no correction or revision is made, such that display effect of a picture is influenced. Thus, the sub-pixels 7 and 8 having the same color as described above are chosen as sampling points to obtain the voltage difference data.

Referring to FIG. 1, the display data storage unit 1 is connected with data lines of respective pixel units in the LCD; a first input terminal and a second input terminal of the operational amplifier 41 are connected with different pixel units in the LCD through the sampling data line 2; and an output terminal of the operational amplifier 41 is connected with the voltage difference storage unit 4.

In operation, the central processor 5 controls the display data storage unit 1 to output the sampling display data to the respective pixel units in the LCD, then the sampling unit samples voltages values on sub-pixels of each pixel that correspond to the sampling display data, and then the voltage values are amplified and converted into digital signals by the operational amplifier 41 to obtain the voltage difference data, which is stored in the voltage difference storage unit 4 to be used as a basis for revising the original display data or the sampling display data.

Additionally, the first input terminal of the operational amplifier 41 is a non-inverting input terminal, while the second input terminal of the operational amplifier 41 is an inverted input terminal; or, the second input terminal of the operational amplifier 41 is a non-inverting input terminal, while the first input terminal of the operational amplifier 41 is an inverted input terminal. The first input terminal and the second input terminal may be the non-inverting input based on practical requirement.

An embodiment of the present disclosure further discloses a liquid crystal display device, which comprises the drive circuit for improving display effect of LCD as described in the above embodiments.

As compared with prior arts, the liquid crystal display device provided by the disclosure has the same beneficial effect as that of the drive circuit for improving display effect of LCD. That is, they both retrieve the voltage difference data from the voltage difference storage unit 4 to revise voltage values in the original display data or in the sampling display data, so as to improve display effect of original display data in different pixel units, that is, an overall display effect of a picture may be improved.

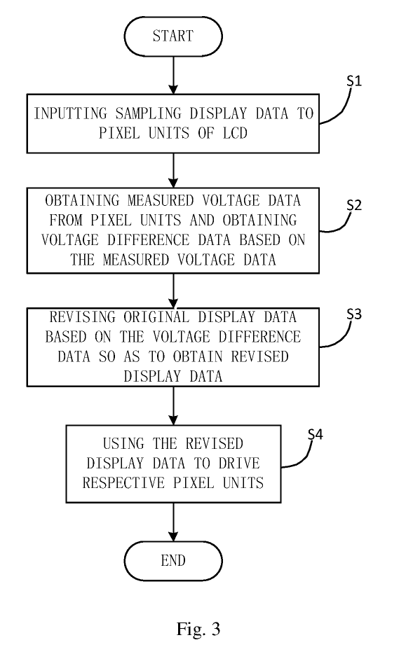

Please refer to FIG. 3, an embodiment of the present disclosure further provides a method for improving display effect of a LCD. The method may be carried out through the drive circuit for improving display effect of LCD provided in embodiment described hereinbefore. The method may include the following steps of:

S1: inputting sampling display data to pixel units of a LCD;

S2: obtaining measured voltage data from the pixel units, and determining voltage difference data based on the measured voltage data;

S3: revising original display data based on the voltage difference data and obtaining revised display data; and

S4: using the revised display data to drive the respective pixel units of the LCD.

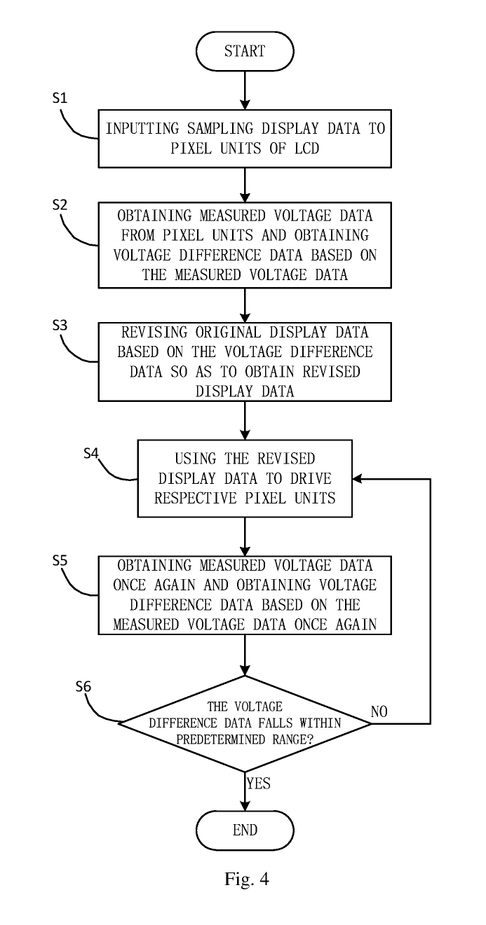

Optionally, as shown in FIG. 4, the method according to another embodiment may further comprise the following steps on the basis of the embodiment shown in FIG. 3:

S5: obtaining measured voltage data once again and obtaining voltage difference data based on the measured voltage data once again; and

S6: determining whether or not the voltage difference data falls within a predetermined range, and ending the revising if the voltage difference data falls within the predetermined range, and revising original display data based on the voltage difference data and repeating steps S4 to S6 if the voltage difference data falls out of the predetermined range.

In step S1, specifically, the central processor 5 controls the display data storage unit 1 to input the sampling display data to a pixel unit(s) of the LCD; preferably, when inputting the sampling display data, a low level is inserted to prevent each set of the sampling display data from interfering each other.

When performing the method, during inputting the sampling display data to the respective pixel units, a low level is inserted between every two adjacent sets of sampling display data, that is, a black picture is inserted. Inserting the low level during inputting the sampling display data may provide more time for transmission and sampling of two adjacent sets of sampling display data, so as to prevent each set of the sampling display data from interfering each other.

In an embodiment, the drive circuit for improving display effect of LCD further includes: the sampling unit comprising the sampling data line 2; the display data storage unit 1 for storing original display data and sampling display data; the voltage difference storage unit 4 for storing voltage difference data; and the operational amplifier 41 for processing the measured voltage data to obtain the voltage difference data.

The sampling unit transmits the sampling display data through the sampling data line 2 and provides the measured voltage values of the pixel units or the sub-pixels to the operational amplifier 41; the operational amplifier 41 obtains the measured voltage values through the sampling data line 2 and obtain the voltage difference data through calculations; then the voltage difference data may be stored in the voltage difference storage unit 4; the central processor 5 retrieves the voltage difference data from the voltage difference storage unit 4.

During operation, the operational amplifier 41 may amplifies and processes (for example, conversion to digital signals) the measured voltage values obtained by the sampling data line 2; the voltage difference data obtained through processing is stored in the voltage difference storage unit 4 to be retrieved by the central processor 5.

The steps S5 and S6 provide verification on the first revision, and the display data may be revised again based on a result of the verification. Such verification and re-revision may be repeated, until a desired display effect is obtained. In an exemplary embodiment, it is determined whether the voltage difference data has fallen within a predetermined range. If it has fallen within the predetermined range (for example, the voltage difference value is zero or falls within a small range close to zero), it is determined that a desired display effect is substantially met. Otherwise, one or more revisions are performed on the display data based on currently measured voltage difference data, until the voltage difference data has fallen within the predetermined range.

An embodiment of the present disclosure further provides a drive method for a LCD device, including the method for improving display effect of LCD according to the embodiment described hereinbefore.

As compared with prior arts, beneficial effect of the liquid crystal display device provided by the disclosure is same as that of the driving method for improving display effect of LCD, which will be omitted herein.

The embodiments described above are specific examples of the disclosure, and the disclosure is not limited thereto. All variations and substitutions made by those skilled in the art without departing from the scope of the disclosure should be covered by the scope of the disclosure. Therefore, the scope of the disclosure is defined by the scope of the appended claims.

1. A drive circuit for improving display effect of LCD, comprising a display data storage unit, a voltage difference storage unit and a central processor, wherein
the display data storage unit is configured to store original display data and sampling display data;
the central processor is connected with the display data storage unit and the voltage difference storage unit respectively; and
the central processor is configured to: input the sampling display data in the display data storage unit to respective pixel units of the LCD, obtain measured voltage data on the respective pixel units corresponding to the sampling display data, obtain voltage difference data based on the measured voltage data, revise the original display data in the display data storage unit based on the voltage difference data to obtain revised display data, and input the revised display data to the respective pixel units of the LCD.

2. The drive circuit according to claim 1, further comprising an operational amplifier, wherein
the operational amplifier is configured to obtain the measured voltage data and process the measured voltage data to obtain the voltage difference data;
the voltage difference storage unit is configured to store the voltage difference data; and
the central processor is further configured to retrieve the voltage difference data from the voltage difference storage unit.

3. The drive circuit according to claim 2, further comprising a sampling unit having a sampling data line, and the sampling data line is configured to transmit the sampling display data and provide the measured voltage data to the operational amplifier.

4. The drive circuit according to claim 3, wherein
the display data storage unit is connected with data lines for the respective pixel units in the LCD;
a first input terminal and a second input terminal of the operational amplifier are connected with different pixel units or sub-pixel units in the LCD through the sampling data line; and
an output terminal of the operational amplifier is connected with the voltage difference storage unit.

5. The drive circuit according to claim 4, wherein
the first input terminal of the operational amplifier is a non-inverting input terminal, while the second input terminal of the operational amplifier is an inverted input terminal; or,
the second input terminal of the operational amplifier is a non-inverting input terminal, while the first input terminal of the operational amplifier is an inverted input terminal.

6. A liquid crystal display device, comprising the drive circuit according to claim 1.

7. A method for improving display effect of LCD, comprising steps of:
S1: inputting sampling display data to pixel units of the LCD;
S2: obtaining measured voltage data from the pixel units and obtaining voltage difference data based on the measured voltage data;
S3: revising original display data based on the voltage difference data so as to obtain revised display data; and
S4: using the revised display data to drive respective pixel units of the LCD.

8. The method according to claim 7, wherein after the step of S4, the method further comprises steps of:
S5: obtaining measured voltage data once again and obtaining voltage difference data based on the measured voltage data once again; and
S6: determining whether or not the voltage difference data falls within a predetermined range, ending the revising if the voltage difference data falls within the predetermined range, and revising the original display data based on the voltage difference data and repeating steps S4 to S6 if the voltage difference data falls out of the predetermined range.

9. The method according to claim 7, wherein when inputting the sampling display data or revising the display data, a low level is applied to prevent each set of the sampling display data or the revised display data from interfering each other.

10. The method according to claim 9, wherein the step of S1 comprises transmitting the sampling display data and the revised display data through a sampling data line.

11. The method according to claim 9, wherein the step of S2 comprises providing the measured voltage data from the different pixel units through a sampling data line.

12. The method according to claim 11, wherein the step of S2 further comprises using an operational amplifier to process the measured voltage data to obtain the voltage difference data.

13. A liquid crystal display device, comprising the drive circuit according to claim 2.

14. A liquid crystal display device, comprising the drive circuit according to claim 3.

15. A liquid crystal display device, comprising the drive circuit according to claim 4.

16. A liquid crystal display device, comprising the drive circuit according to claim 5.

17. The method according to claim 8, wherein when inputting the sampling display data or revising the display data, a low level is applied to prevent each set of the sampling display data or the revised display data from interfering each other.

18. The method according to claim 17, wherein the step of S1 comprises transmitting the sampling display data and the revised display data through a sampling data line.

19. The method according to claim 17, wherein the step of S2 comprises providing the measured voltage data from different pixel units through a sampling data line.

20. The method according to claim 19, wherein the step of S2 further comprises using an operational amplifier to process the measured voltage data to obtain the voltage difference data.
